(19) United States
(12) Patent Application Publication
(10) Pub. No.: US 2015/0347937 A1
(43) Pub. Date: Dec. 3, 2015

(54) Characterizing Risks in Resource Distribution Systems

(71) Applicant: HEWLETT-PACKARD DEVELOPMENT COMPANY, L.P., Houston, TX (US)

(72) Inventors: Martin Arlitt, Calgary (CA); Manish Marwah, Palo Alto, CA (US); Amip J. Shah, Palo Alto, CA (US)

(21) Appl. No.: 14/759,658

(22) PCT Filed: Jan. 9, 2013
(86) PCT No.: PCT/US13/20884

§ 371 Date: Jul. 8, 2015

(51) Int. Cl. G06Q 10/06; G06N 99/00; G06Q 50/06; G06N 5/04

(52) U.S. Cl. CPC G06Q 10/0635; G06N 5/046; G06N 99/005; G06Q 50/06

(57) ABSTRACT

Characterizing risks in resource distribution systems includes collecting measurements from multiple end users in a resource distribution system and identifying a subset of the end users that pose a greater than average risk to the resource distribution system with a risk identification engine.

### BACKGROUND

Many utility providers of resources such as electricity, gas, and water use meters located at consumer residences, businesses, or other buildings that are connected to the utility provider's resource distribution system. These meters collect data regarding how much of the resource the consumer is using. Often, the utility company references the meters on a periodic basis, such as monthly, to determine how much to charge the consumer for their utilization of the resource.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a resource distribution system according to principles described herein.

FIG. 2 is a chart of an example of resource consumption according to principles described herein.

FIG. 3 is a diagram of an example of a method for characterizing risks in resource distribution systems according to principles described herein.

FIG. 4 is a diagram of an example of a method for characterizing risks in resource distribution systems according to principles described herein.

FIG. 5 is a diagram of an example of a characterization system according to principles described herein.

FIG. 6 is a diagram of an example of a characterization system according to principles described herein.

FIG. 7 is a diagram of an example of a flowchart of a process for characterizing risks in resource distribution systems according to principles described herein.

### DETAILED DESCRIPTION

Strains on the resource distribution system can lead to failures, such as electrical power failures, due to excessive demand for the resource. In particular, over users of a resource, especially at peak consumption hours, pose a risk to the resource distribution system. However, merely checking a meter on a monthly basis for billing purposes fails to inform the utility providers of which of their resource end users are posing the greatest risks to their system.

Another risk faced by utility companies is fraud. Some end users purposefully disconnect or otherwise manipulate their meters for short or prolonged periods of time while continuing to use the distribution system's resource without detection. This wrongfully lowers the fraudulent end user's monthly resource consumption bill. It may also mislead the utility provider into believing that there is a smaller demand for the system's resource. As a consequence, a utility provider's output may fall short of the actual demand which can contribute to blackouts or other failures.

The principles described herein include a method for identifying risks to a resource distribution system that allow the utility provider to take corrective actions (e.g., to either combat fraud or to provide conservation options to over users of a resource). The method includes collecting measurements from multiple end users in a resource distribution system with multiple remote meters at usage locations of the multiple end users and identifying a subset of the end users that pose a greater than average risk to the resource distribution system with a risk identification engine. Further, the end users may be ranked according to their risk. Thus, the utility provider may determine the subset with a specific percentile of the end users according to their risk. For example, the subset may include the top ten percent of users who pose the greatest risk.

The utility provider can establish the criteria that it considers to pose a greater than average risk. For example, the utility provider may determine that over users, i.e., end users who use a significantly greater amount of resources than other end users, pose a risk to the resource distribution system. Also, the utility provider may determine that under users, i.e., end users who use or appear to use a significantly smaller amount of resources than other end users, pose a risk because they may be committing fraud.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

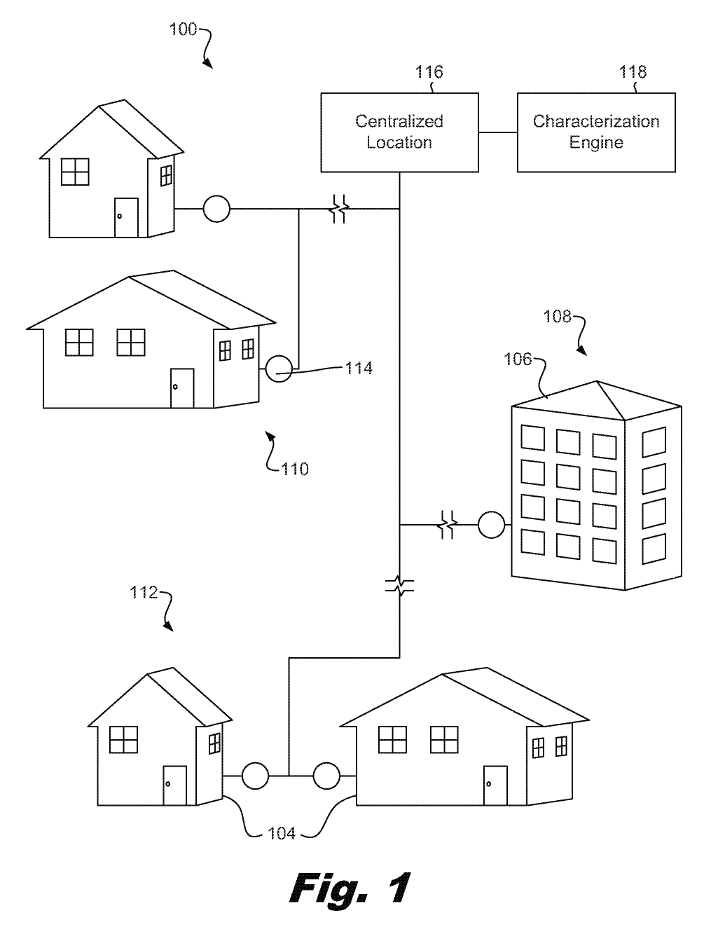

FIG. 1 is a diagram of an example of a resource distribution system (100) according to principles described herein. In this example, the resource distribution system (100) distributes a utility resource to dwellings, such as homes (104) and other buildings (106), in different geographic locations (108, 110, 112). The resource may be electricity, gas, water, other resources, or combinations thereof.

Each home (104) and building (106) has a line from the resource distribution system (100) that supplies the resource. A meter (114) is attached to the incoming line, which measures the amount of the resource that passes by the meter into the homes (104) and buildings (106). Each of the meters (114) has the capability of sending its measurements to a centralized location (116) in the resource distribution system (100). In alternative examples, the data is sent to and stored within a distributed system. The distributed system may aggregate the data into a single view to be analyzed collectively.

The meters (114) transmit the measurements wirelessly or the meters transmit the measurements on an electrically conductive medium wired into the resource distribution system (100). In some examples, the data is transmitted wirelessly across some sections of the resource distribution system, and transmitted with an electrically conductive medium through other sections. In some examples, the data is transmitted wirelessly to a concentrator. Data from multiple meters is aggregated at the concentrator. Further upstream, a head-end system aggregates data from multiple concentrators. The head-end system or systems transmit the data to the centralized location or distributed data system.

The measurements may be a total measurement since the meter was activated, or the measurements may be the total measurement since the last measurement was reported. In addition to sending the measurement information, the meters (114) may also send other data, such as the geographic location of the dwelling, size of the dwelling, type of dwelling, user end identification, other information, or combinations thereof.

A characterization engine (118) is in communication with the centralized location (116) and collects the data from each of the reporting meters (114). The characterization engine (118) classifies each of the reporting meters into classifications that describe a common characteristic of the dwellings associated with the meters. The classifications may include a dwelling type, such as a residential home, an industrial plant, an office building, another type of building, or combinations thereof. Another classification may include the size of the building, and yet another classification may include the geographic location of the dwellings. The classification categories may sort the meters with fine-grained details or with more coarse details. Fine-grained classifications may include dwelling square footage, number of residents, age of residents, type of appliances, number of appliances, age of appliances, weather conditions, other fine-grained details, or combinations thereof.

In some examples, each dwelling is assigned to a single classification, while in other examples, the dwellings can be assigned to multiple classifications. The classifications allow the characterization engine (118) to compare each of the dwellings against other dwellings with common characteristics (i.e., its peers). Such classifications avoid comparing the resource consumption of a large office building directly to the resource consumption of a small residence, to more accurately identify over and under users.

The characterization engine (118) compares the consumption measurements of each of the dwellings within each classification. As a result, the characterization engine (118) can determine which of the dwellings in each classification has a relatively high resource consumption, a relatively low resource consumption, a relatively normal resource consumption, other characteristics, or combinations thereof. Within each classification, the characterization engine (118) follows the rules of a characterization policy to determine which of the dwellings has a greater than average risk to the resource distribution system (100). For example, the characterization policy may indicate that the highest ten percent of resource consumers per classification has a greater than average risk to the resource distribution system (100). Another example includes a rule that indicates that the lowest ten percent of resource consumers per category has a higher than average risk to the resource distribution system (100). In yet another example, a rule indicates that end users that are more or less than three standard deviations from the mean usage within their classifications pose a risk to the resource distribution system. Other rules may include predetermined resource consumption thresholds, more sophisticated rules that consider other parameters, other rules, or combinations thereof.

Not all of the dwellings which are deemed to pose a higher risk to the resource distribution system (100) may actually be dangerous to the resource distribution system (100). For example, an end user using resource efficient appliances may fall within the lowest ten percent within its classification and pose no danger to the resource distribution system (100). Further, dwellings that locally generate energy, such as solar panels or wind turbines may also pose little or no risk to energy resource distribution systems. As such, the characterization rules are for indicating which of the dwellings should be subjected to a more detailed analysis. While performing a detailed analysis on every dwelling receiving resources from the resource distribution system (100) may reveal all of the actual risks, such an extensive analysis is costly and time prohibitive. Thus, by limiting the more detailed analysis to just the highest risk dwellings, the characterization resources are used more efficiently.

The characterization engine (118) can extract statistics, such as the average resource consumption, the top users, the bottom users, and so forth, from each category to generate a report. The report may include which dwellings are deemed to be a higher risk and include a recommendation for how to address the risks. For example, the recommendations can include providing resource conservation options and incentives to the end users. Another recommendation includes manually inspecting the meters reporting under usage. Such an inspection may reveal fraudulent activity or broken meters. In other examples, the recommendations may include more customized actions based on multiple considerations.

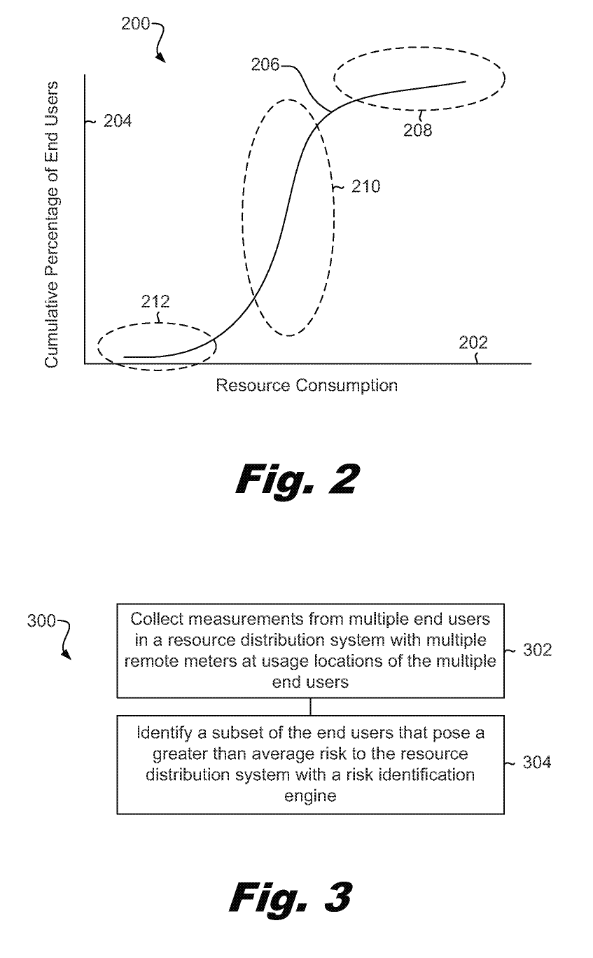

FIG. 2 is a chart (200) of an example of resource consumption according to principles described herein. In this example, the x-axis (202) schematically represents the amount of resource consumption, and the y-axis (204) schematically represents the cumulative percentage of end users within one of the classifications.

The characterization engine uses the shape of the line (206) to determine over users, under users, and normal users. For example, the top of the line (206) flattens out indicating that a relatively small percentage of the end users are consuming a significant amount of the resource. Thus, this first group (208) of end users that is schematically represented with the top portion of the line is considered a group of over users. Likewise, a second group (212) of end users schematically represented with the bottom of the line (206) is considered to be a group of under users. A third group (210) of end users is schematically represented with the middle of the line (206) where the line's slope is the steepest. This group represents the resource consumption of a normal user.

The characterization engine retrieves the data about each of the dwellings in a specific classification and creates a corresponding chart, such as the chart (200) in the example of FIG. 2. The characterization engine can follow a set of rules for determining which portions of the line (206) represent over users, normal users, and under users.

In other examples, the characterization engine uses other mechanisms to determine which end users are under users, over users, and normal users. For example, the characterization engine may determine that any end users that use below a predetermined amount of the resource are under users, and any end users that use above a predetermined amount of the resource are over users. In other examples, more complicated functions that consider additional circumstances determine the over users and the under users, such as clustering mechanisms, probability distribution mechanisms, other mechanisms, or combinations thereof. The probability distribution mechanisms may include Gaussian mechanisms, student's t mechanisms, log-normal mechanisms, or other mechanisms that determine outliers. Such outliers may be considered to pose a greater than average risk to the resource distribution system.

The principles described herein also include systems that implement the characterization process. By way of example, one such system may include a database that contains historical end user usage data and end user identification numbers. The system may also contain a data store that temporarily retains and cleans new incoming end user usage values and an analytics engine that implements various analysis functions, such as clustering or statistical analysis. Such a system may also include a rules engine that associates various domain specific interpretations of the different outputs from the analytics engine. Samples of rules that the system implements include determining that any end user whose resource consumption is more than three standard deviations above the mean usage poses a consumption risk to the resource distribution system, especially during peak demands for the resource distribution system's resource. The system may also provide a set of actions that are related to the system's interpretations. One such action can include providing an incentive for an on-site photovoltaic device to lower the end user's electricity demand if the end user poses a day time consumption risk during peak demands. The system may also include a service activator that generates, transmits, and tracks the status of the various actions recommended from the rules engine.

FIG. 3 is a diagram of an example of a method (300) for characterizing risks in resource distribution systems according to principles described herein. In this example, the method (300) includes collecting (302) measurements from multiple end users in a resource distribution system with multiple remote meters at usage locations of the multiple end users and identifying (304) a subset of the end users that pose a greater than average risk to the resource distribution system with a risk identification engine. The risk identification engine identifies and quantifies the end users who pose greater than average risks to the resource distribution system. Such end users who pose such risk may be over or under users of the distribution system's resource.

The method may also include classifying the end users into classifications that group the end users with common characteristics together. A non-exhaustive list of such common characteristics includes geographic location, dwelling size, dwelling type, other characteristics, or combinations thereof.

The subset of end users that pose a greater than average risk to the resource distribution system may be over users or under users of the system's resources. A report can be generated that lists the end users deemed to pose a greater than average risk to the resource distribution system. The report may include recommendations for addressing these risks. The recommendations may include investigating the meters associated with the subset of end users, giving conservation options to the over users, giving conservation options to the normal users, other recommendations, or combinations thereof.

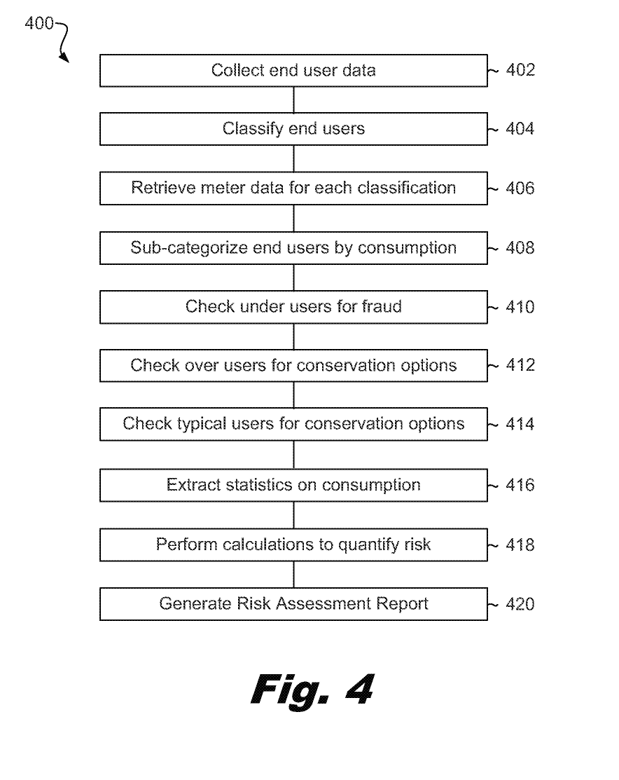

FIG. 4 is a diagram of an example of a method (400) for characterizing risks in resource distribution systems according to principles described herein. In this example, the method (400) includes collecting (402) end user data, classifying (404) the end users, retrieving (406) meter data for each classification, sub-categorizing (408) end users by consumption, checking (410) under users for fraud, checking (412) over users for conservation options, checking (414) normal users for conservation options; extracting (416) statistics on consumption from each classification, performing (418) calculations to quantify the risk of a subset of end user deemed to pose a significant risk to the resource distribution system, and generating (420) a risk assessment report.

The data for each end user is collected from the remote sensors and stored in a database. The data is retrieved by the characterization engine on a periodic basis; an on-demand basis; another basis, or combinations thereof.

The data of interest retrieved by the characterization engine includes a unique end user identifier. This identifier may have an integer value (e.g., an account number). However, if the database stores the end user's first and last name instead of an integer value or with some other identifier, the identifier can be converted to an integer value via a lookup table or another similar mechanism. Other data of interest includes the end user's geographic location, the end user's type of dwelling, the end user's size of dwelling, other information, or combinations thereof.

The end users are grouped into different classifications, where end users within each classification have common characteristics. For example, the common characteristics can include the same city, the same neighborhood, the same dwelling type, the same dwelling size, age of the end user's dwelling, the installation of resource conservation appliances, other common characteristics, or combinations thereof. The end users may be classified using clustering mechanisms, decision trees, historical records, previous classifications, other mechanisms, or combinations thereof.

The end users are analyzed together within each classification. Such analysis may be implemented with a program that runs on a computer system. The program reads the data from files stored on the computer system, or directly from the database or other applications that are storing the end user and/or meter data via a computer network.

Meter data for each end user in the classification is retrieved. The type of meter data retrieved will vary depending on the assessment performed. As an example, for electric providers a time series of electricity consumption may be retrieved, or in some cases a time series of multiple metrics (e.g., electricity consumption and voltage) is retrieved. If the utility provider provides multiple resources (e.g., electricity, gas, and/or water), then data for each resource can be examined independently or together. The retrieved meter data may be stored in a temporary file or read directly into the memory of the analysis program.

The end users within the given classification are sub-categorized according to the amount of resource consumed, which is determined by using the meter data. Sub-categorizing the end user may involve using a cumulative distribution mechanism such as by ordering the total resource consumption of an end user over a given period of time.

A set of under users within the classification is identified using the sub-categorizing process. At least a subset of under users may be using more of a resource than indicated by reading the meter either due to a faulty meter or fraud. To further investigate the under users, the system can recommend manually inspecting the dwelling or the meter or another form of investigation. For example, a technician can be sent to the under user's dwelling to determine if the meter is functioning properly, is disconnected, or has been tampered with. Also, the investigation may use the remote sensing mechanism to gather more data about the under user under investigation.

In some examples, the end users are using resource efficient appliances, which is revealed upon further investigation of the under users. As such, these under users will be labeled as efficient users and will be excluded from future manual investigations when the end user shows up in future a subset of end users labeled as under users. This further narrows the number of end users who should be investigated for committing fraud or have broken meters.

The sub-categorization process may also identify a set of over users, who are using substantially more of a resource than their peers. The over users pose a risk to the provider in several ways. First, over users can push the provider's peak usage into unsafe regions risking an outage. Second, for utility providers that allow credit-based billing where the end user pays after consumption rather than pre-pay there is a risk that the end user will not pay. For example, some illegal activities, such as growing marijuana, can consume a lot of energy and there is a risk to the utility provider that the end user will vacate the dwelling suddenly without paying for the resources already consumed. The utility provider may offer special incentives to the over users, such as discounts on resource efficient appliances or an inspection of the dwelling to provide personalized feedback on how to reduce resource consumption.

In some examples, the utility provider examines the normal users to explore opportunities to improve their resource consumption, especially during their peak usage. The normal users are lower priority to examine than the over users so the analysis of the normal end users can be scheduled during a slow period or after the over users have been addressed. In some cases, the normal users are given smaller incentives than the over users to entice them to lower their resource consumption levels. The utility provider may provide greater incentives to over users than normal users, as that may motivate the higher risk group to participate in the conservation program, and thus have a greater risk mitigation effect on the distribution system.

Statistics, such as average consumption, median, quantile and/or percentile benchmarking, other statistics, or combinations thereof are extracted from the various classifications and sub-categories. The statistics are used to quantitatively evaluate the changes in consumption that have resulted over time due to factors such as demand response initiatives by the utilities provider.

The statistics are used to describe the risks to the utility. For example, a risk index may be generated and associated with each end user or meter that relates what the qualitative likelihood or quantitative probability that the end user is causing issues for the resource distribution system. Such likelihoods or probabilities may be based on historical records. A non-exhaustive list of issues includes financial revenue issues, peak usage issues, inspection frequency issues, other issues, or combinations thereof. Such a risk index may be used to further prioritize those end users identified previously who are of low risk because of their efficient use of the resource.

Any appropriate risk index to quantify the likelihood of the end user committing fraud or quantify other risks the end user poses to the resource distribution system may be used in accordance with the principles described herein. In some examples, all of the meters are ranked based on their risk to the resource distribution system and normalized according to the following formula: Rᵢ=1−rᵢ/N where Rᵢ is the corresponding assigned rank and N is the total number of users. An Rᵢ of 1 is assigned to the user posing the greatest risk to the resource distribution system, and N to the user posing the lowest risk. In such an example, the risk index Rᵢ is bounded between 0 and 1, where represents the user posing the greatest risk.

The characterization engine causes a report to be generated that includes recommended actions for the utility provider to take. Such recommendations may include sending a technician to the dwellings of specific end users to test the meter and to check for tampering, sending a high priority incentive to specific end users, sending priority incentives to specific end users, other recommended actions, or combinations thereof. These actions can also be linked to the type of risk posed. For example, recommended actions associated with resource production due to peak usage risk factors may be sent to a group posing a specific type of risk, while risks associated with end users who are tampering with the meters may be sent to a different group of end users.

The above described methods can be applied over various time periods. For example, one approach is to characterize each end user at the same frequency as the billing cycle, monthly or quarterly. However, the methods can be applied more frequently such as hourly, daily, or weekly to alert the utility to emerging issues. In other examples, the methods are applied over longer time periods, such as annually. The methods can also be done over multiple time periods, such as weekly to identify emerging issues, monthly to provide feedback or incentives to end users as part of the billing cycle, and annually to assess the progress being made to opportunistically reshape demand.

In alternative examples, the system automatically makes recommended actions in response to a user posing a risk below or above a certain threshold. For example, the characterization engine may communicate with the billing system over a computer network to inform the billing system to include high priority incentives to the recipients of the bills for specific dwellings. The system records to which end users such incentives were offered and which end users took advantage of such offers. The characterization engine consults with the records of which end users received and/or took advantage of these offers when later considering the end user's status as an under user or the amount of risk that an end user poses to the resource distribution system on the risk index.

In other examples, the characterization engine retrieves supplemental data about a meter in addition to the resource usage data for the meter. For example, a loss prevention analysis includes searching for situations where over a fixed time interval the cumulative consumption of the meters attached to a transformer (for electric distribution systems), pump (for water distribution systems), or compressor station (for gas distribution systems) is less than the quantity of the monitored resource traversing the transformer, pump, or compressor. If a significant loss is detected, then all of the meters attached to the transformer, pump, or compressor are flagged. If the loss is substantial enough to indicate a high risk of delivering the resource rather than just a fraud risk, the utility provider may deploy technicians to the area to search for signs of a broken pipe or a grounded electrical line. For smaller losses, the utility provider can wait for the analysis results before dispatching technicians to help focus their efforts to finding the source of the issue.

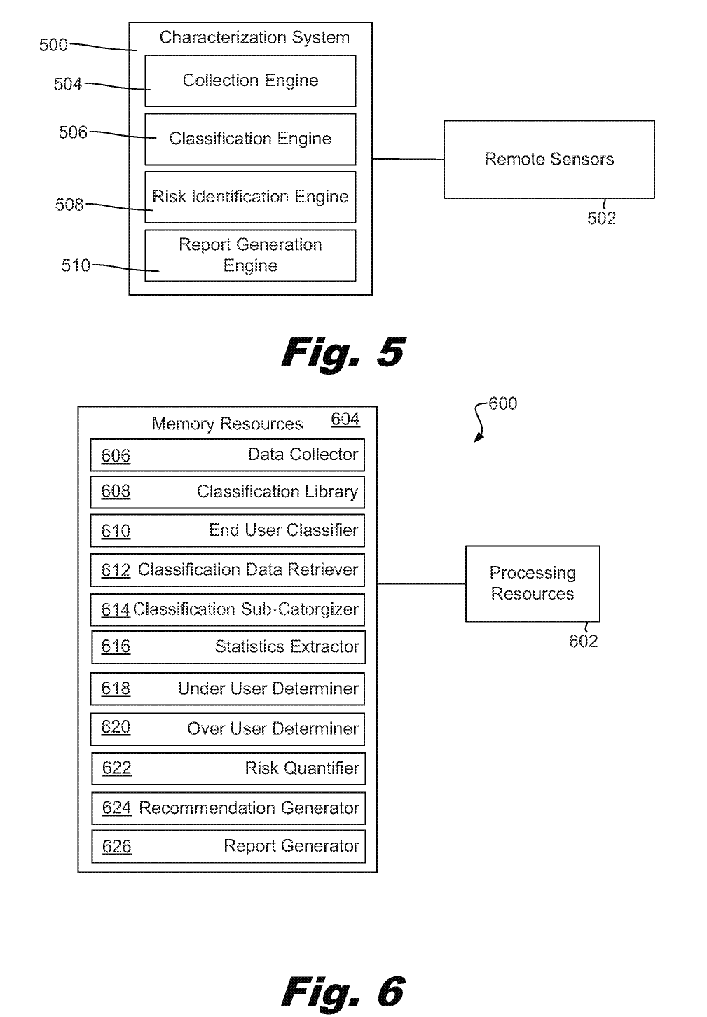

FIG. 5 is a diagram of an example of a characterization system (500) according to principles described herein. In this example, the characterization system (500) is in communication with the remote sensors (502) of the resource distribution system. The characterization system (500) also includes a collection engine (504), a classification engine (506), a risk identification engine (508), and a report generation engine (510). The engines (504, 506, 508, 510) refer to a combination of hardware and program instructions to perform a designated function. Each of the engines (504, 506, 508, 510) may include a processor and memory. The program instructions are stored in the memory and cause the processor to execute the designated function of the engine.

The collection engine (504) collects data from the remote sensors (502) of the resource distribution system. The collection engine (504) includes a database or the ability to retrieve the information from a database that stores the information from the remote sensors (502). The information collected with the collection engine (504) allows the classification engine (506) to identify each end user, to classify the end users into classifications with common characteristics, and to sub-categorize the end users within each classification based on the end user's resource consumption amount.

The risk identification engine (508) identifies which of the end users poses a risk to the resource distribution system. For example, the risk identification engine (508) determines which of the end users are over users or under users of the resource distribution system's resource. The report generation engine (510) generates a report that includes which of the end users pose a risk. The report may also include recommendations for addressing the subset of end users posing a risk. Such a recommendation may include recommended actions for all of the end users in the report or for groups of the end users in the report, or the recommended action may be customized for individual end users that are included in the report.

FIG. 6 is a diagram of an example of a characterization system (600) according to principles described herein. In this example, the characterization system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the characterization system (600). The programmed instructions shown stored in the memory resources (604) include a data collector (606), an end user classifier (610), a classification data retriever (612), a classification sub categorizer (614), an under user determiner (618), an over user determiner (620), a statistics extractor (616), a risk quantifier (622), a recommendation generator (624), and a report generator (626). The data structures shown stored in the memory resources (604) include a classification library (608).

The memory resources (604) include a computer readable storage medium that contains computer readable program code to cause tasks to be executed by the processing resources (602). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The data collector (606) represents programmed instructions that, when executed, cause the processing resources (602) to collect data from the remote sensors of the resource distribution system. The data may be collected directly from the remote sensors. In some examples, the data collector (606) requests the data from the remote sensors directly or from a database that stores the data. An end user classifier (610) represents programmed instructions that, when executed, cause the processing resources (602) to classify the end users into classifications based on common characteristics, such as a dwelling size, that is determined from the data from the data collector (606). The classification types are stored in a classification library (608), which is a data structure stored in the memory resources (604). In other examples, the classifications are stored in a more persistent manner, such as a database, which can enable additional studies of the end users' demographics.

A classification data retriever (612) represents programmed instructions that, when executed, cause the processing resources (602) to retrieve data from the data collector (606) about each of the end users within a classification. The classification sub-categorizer (614) represents programmed instructions that, when executed, cause the processing resources (602) to sub-categorize the end users within each category based on their resource consumption.

The statistics extractor (616) represents programmed instructions that, when executed, cause the processing resources (602) to extract statistics such as the mean, variance, and so forth from the classifications. The under user determiner (618) represents programmed instructions that, when executed, cause the processing resources (602) to determine which of the end users within each classification are using a significantly smaller amount of the resource compared to the other end users in the same category or for the characteristics of the end user's dwelling. The over user determiner (620) represents programmed instructions that, when executed, cause the processing resources (602) to determine which of the end users within each classification are using a significantly larger amount of the resource compared to the other end users in the same category or for the characteristics of the end user's dwelling.

The risk quantifier (622) represents programmed instructions that, when executed, cause the processing resources (602) to quantify the risk of each of the end users indentified as posing a greater than average risk to the resource distribution system. The risk quantifier (622) uses the extracted statistics from the current analysis as well as statistics from historical records to determine the risk.

A recommendation generator (624) represents programmed instructions that, when executed, cause the processing resources (602) to generate a recommend for specific or groups of end users deemed to pose a risk. The recommendations may be customized for individual end users where multiple factors are considered. Alternatively, a set of rules causes the recommendation generator (624) to determine that all over users receive the same recommendation. Likewise, a set of rules may cause the recommendation generator (624) to determine that all of the over users receive the same recommendation as well. A report generator (626) represents programmed instructions that, when executed, cause the processing resources (602) to generate a report that includes the end users identified as posing a risk and a recommendation for each of the end users in the report.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the characterization system (600) may be implemented on a user device, on a server, on a collection of servers, or combinations thereof.

The characterization system (600) of FIG. 6 may be part of a general purpose computer. However, in alternative examples, the characterization system (600) is part of an application specific integrated circuit.

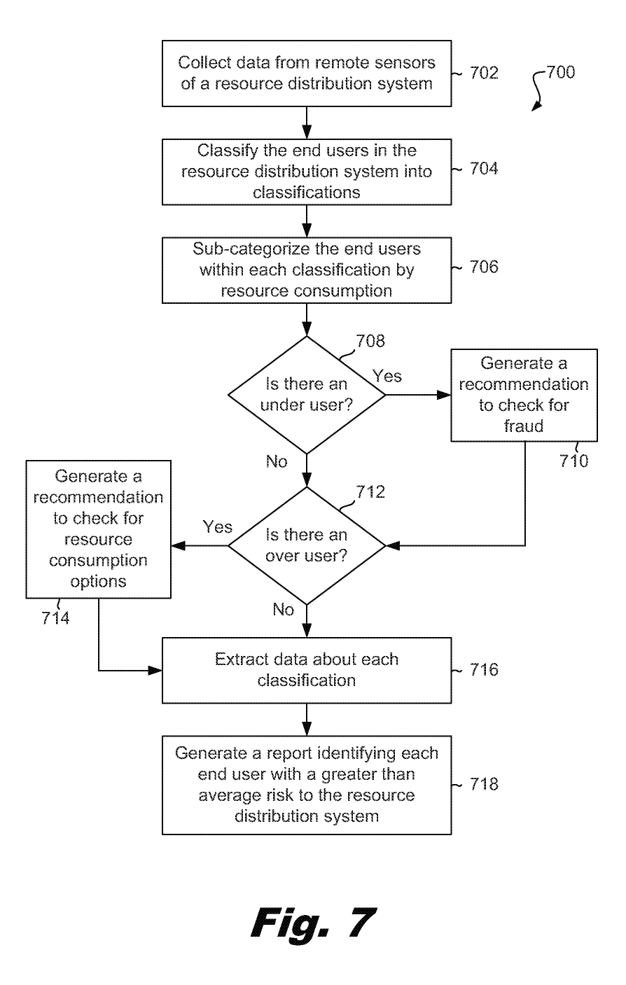

FIG. 7 is a diagram of an example of a flowchart (700) of a process for characterizing risks in resource distribution systems according to principles described herein. In this example, the process includes collecting (702) data from remote sensors of a resource distribution system, classifying (704) the end users in the resource distribution system into classifications, and sub-categorizing (706) the end users within each classification by resource consumption.

The process also include determining (708) whether there is an under user. If there is an under user, the process includes generating (710) a recommendation to check for fraud. The process also includes determining (712) whether there is an over user. If there is an over user, the process includes generating (714) a recommendation to check for resource conservation options. In some examples, when the process determines that, when the end user is neither an over user or an under user, the end user is a normal user. If the process determines that the user is a normal user, the process also includes making a recommendation to check the normal user for conservation options.

Statistics about each of the end users in each of the classifications is extracted (716). The statistics are used to generate (718) a report that identifies each of the end users posing a greater than average risk to the resource distribution system. The recommendations for addressing the under users and the over users are included in the report.

The principles described herein provide a systematic way to sift through large amounts of end user data and meter data and to prioritize actionable information for the utility provider to improve its operations. In some examples, the determinations along with the associated recommended actions and responses are recorded during each characterization analysis so that the accuracy of the recommendations improves over time. The system can also be extended to automate some of the actions to further reduce the workload on employees of the utility provider.

While the examples above have been described with reference to specific resources and resource distribution systems, any appropriate resource or resource distribution system compatible with the principles described herein may be used. Also, while the above examples have been described with reference to specific classifications and dwelling types, any appropriate classification or dwelling type may be used with the principles described herein.

Further, while the examples above have been described with reference to specific mechanisms, processes, and rules for determining which end users pose a risk to the resource distribution system, any appropriate mechanism, process, and/or rule compatible with the principles described herein may be used. Also, while the above examples have been described with reference to specific ways of collecting and retrieving the data about the end user's consumption, any appropriate mechanism and/or process for collecting and/or retrieving the data may be used.

While the examples above have been described with reference to specific types of recommendations, ways to determine fraud, ways to inspect the meters, or ways to lower over user's consumption, any appropriate recommendation, way to address fraud, and/or way to address over users may be used in accordance with the principles described herein. Also, while the examples above have been described with reference to specific information to be included in the report, any appropriate information may be included in the report in accordance to the principles described herein.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for characterizing risks in resource distribution systems, comprising:
collecting measurements from multiple end users in a resource distribution system; and
identifying a subset of said multiple end users that pose a greater than average risk to said resource distribution system with a risk identification engine.

2. The method of claim 1, wherein identifying said subset of said multiple end users that pose said greater than average risk to said resource distribution system with said risk identification engine includes indentifying over users of a resource distributed with said resource distribution system.

3. The method of claim 1, wherein identifying said subset of said multiple end users that pose said greater than average risk to said resource distribution system with said risk identification engine includes indentifying under users of a resource distributed with said resource distribution system.

4. The method of claim 1, wherein said resource distribution system distributes water, electricity, gas, or combinations thereof.

5. The method of claim 1, further comprising making a recommendation for addressing said subset of said multiple users that pose said greater than average risk to said resource distribution system.

6. The method of claim 1, wherein identifying said subset of said multiple end users that pose said greater than average risk to said resource distribution system with said risk identification engine includes classifying said multiple end users in classifications with common characteristics.

7. The method of claim 6, wherein said common characteristics include geographic location, dwelling size, type of dwelling, or combinations thereof.

8. The method of claim 1, further comprising generating a report with a report generation engine that includes said subset of said multiple end users that pose a greater than average risk and a recommendation for addressing said subset.

9. A system for characterizing risks in resource distribution systems, comprising:
a collection engine to collect measurements from multiple end users in a resource distribution system from multiple remote meters at usage locations of said multiple end users;
a risk identification engine to identify a subset of said multiple end users that pose a greater than average risk to said resource distribution system; and
a report generation engine to generate a report of said subset and a recommendation for addressing said subset.

10. The system of claim 9, wherein said risk identification engine identifies over users of a resource distributed with said resource distribution system.

11. The system of claim 9, wherein said risk identification engine identifies under users of a resource distributed with said resource distribution system.

12. The system of claim 9, further comprising a classification engine to classify said multiple end users into classifications based on similar characteristics.

13. A computer program product for characterizing risks in resource distribution systems, comprising:
a non-transitory computer readable storage medium, said non-transitory computer readable storage medium comprising computer readable program code embodied therewith, said computer readable program code comprising program instructions that, when executed, cause a processor to:
collect measurements from multiple end users in a resource distribution system with multiple remote meters at usage locations of said multiple end users;
classify said multiple end users into classifications based on their common characteristics;
identify a subset of said multiple end users that pose a greater than average risk to said resource distribution system; and
generate a report of said subset with a recommendation for addressing said subset.

14. The computer program product of claim 13, wherein said subset includes over users of a resource distributed with said resource distribution system, under users of said resource, or combinations thereof.

15. The computer program product of claim 13, wherein said classifications include geographic locations, dwelling sizes, type of dwellings, or combinations thereof.
